(19) United States
(12) Patent Application Publication
(10) Pub. No.: US 2020/0267728 A1
(43) Pub. Date: Aug. 20, 2020

(54) Communication System

(71) Applicants: Nokia Solutions and Networks Oy, Espoo (FI); ALCATEL LUCENT, Nozay (FR)

(72) Inventors: Frank FREDERIKSEN, Klarup (DK); Jianguo LIU, Shanghai (CN); Tao TAO, Shanghai (CN)

(21) Appl. No.: 16/490,112

(22) PCT Filed: Mar. 2, 2017
(86) PCT No.: PCT/CN2017/075470

§ 371 Date: Aug. 30, 2019

(51) Int. Cl. H04W 72/04; H04L 5/00

(52) U.S. Cl. CPC H04W 72/0453; H04L 5/0055; H04W 72/042

(57) ABSTRACT

There is provided a method including determining a first control channel including a first plurality of resources in dependence on a first parameter and the downlink bandwidth; determining a second plurality of resources available on at least a second control channel; and combining the first and second plurality of resources to define an effective control channel for use in signalling acknowledgement data to at least one user apparatus.

### FIELD

The present application relates to a method, apparatus, and computer program.

### BACKGROUND

A communication system can be seen as a facility that enables communication sessions between two or more entities such as user terminals, base stations/access points and/or other nodes by providing carriers between the various entities involved in the communications path. A communication system can be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link.

A user can access the communication system by means of an appropriate communication device or terminal. A communication device of a user is often referred to as user equipment (UE) or as a user apparatus. Throughout the following, these terms will be used interchangeably. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP).

In order to increase the available spectrum, it has been proposed to use the unlicensed spectrum using for example some aspects of UTRAN and/or LTE technology.

### SUMMARY

According to a first aspect, there is provided a method comprising: determining a first control channel comprising a first plurality of resources in dependence on a first parameter and the downlink bandwidth; determining a second plurality of resources available on at least a second control channel; and combining the first and second plurality of resources to define an effective control channel for use in signalling acknowledgement data to at least one user apparatus.

The method may further comprise receiving a broadcast comprising the first parameter prior to determining the first control channel; or storing the first parameter to determine the first control channel, wherein the first parameter is static and is set by a communications protocol.

The at least one second control channel may be at least one of: a physical downlink control channel; and an enhanced physical downlink control channel.

Determining a second plurality of resources may comprise at least one of: determining that at least three resource element groups are available on a physical downlink control channel; determining that at least one control channel element is available on a physical downlink control channel; and determining that at least one enhanced control channel element is available on an enhanced physical downlink control channel

The method may further comprising performing said determining in dependence on at least one second parameter, wherein said at least one second parameter is: I_{PHICH}^{spare} when determining that at least three resource element groups are available on a physical downlink control channel; n_{PHICH}^{CCE} when determining that at least one control channel element is available on a physical downlink control channel; and n_{PHICH}^{ECCE} when determining that at least one enhanced control channel element is available on an enhanced physical downlink control channel.

The method may further comprise only determining a second plurality of resources for transmission in a subframe fulfilling a predetermined transmission opportunity of acknowledgment data. The predetermined transmission opportunity may be at least one of: specific subframes of a downlink transmission burst; and subframes falling within a predefined pattern of subframes. The method may further comprise: transmitting an indication of the predetermined transmission opportunity to a user apparatus; and/or receiving an indication of the predetermined transmission opportunity from a network apparatus.

The method may further comprise: transmitting acknowledgement data to the at least one user apparatus using the effective control channel only when the predetermined transmission opportunity is fulfilled; and/or receiving acknowledgement data from a network apparatus using the effective control channel only when the predetermined transmission opportunity is fulfilled.

The method may further comprise transmitting acknowledgement data to the at least one user apparatus using the effective control channel only when the feedback delay of providing the acknowledgement data is not less than a minimal processing delay.

The method may further comprise: mapping an uplink transmission to one of the first and second plurality of resources using an identification of the uplink transmission. The identification may be a hybrid automatic request process ID. The mapping may comprise implicitly mapping said uplink transmission to one of the first and second plurality of resources. The mapping may comprise: transmitting and/or receiving a signal that indicates a start position of the mapping using said identification of the uplink transmission; and explicitly mapping said uplink transmission to one of the first and second plurality of resources in dependence on the start position.

The method may further comprise: mapping at least one of the first plurality of resources to a first group of user apparatuses; mapping at least one of the second plurality of resources to a second group of user apparatuses; transmitting acknowledgement data for at least one of the first group of user apparatuses on the at least one of the first plurality of resources; and transmitting acknowledgement data for at least one of the second group of user apparatuses on the at least one of the second plurality of resources; or receiving acknowledgement data for at least one of the first group of user apparatuses on the at least one of the first plurality of resources.

The acknowledgement data may be associated with a previous grant-less uplink transmission.

According to a second aspect, there is provided an apparatus comprising at least one processor; and at least one memory comprising code that, when executed on the at least one processor, causes the apparatus to: determine a first control channel comprising a first plurality of resources in dependence on a first parameter and the downlink bandwidth; determine a second plurality of resources available on at least a second control channel; and combining the first and second plurality of resources to define an effective control channel for use in signalling acknowledgement data to at least one user apparatus.

The apparatus may be further caused to receive a broadcast comprising the first parameter prior to determining the first control channel; or to store the first parameter to determine the first control channel, wherein the first parameter is static and is set by a communications protocol.

The at least one second control channel may be at least one of: a physical downlink control channel; and an enhanced physical downlink control channel.

Determining a second plurality of resources may comprise at least one of: determining that at least three resource element groups are available on a physical downlink control channel; determining that at least one control channel element is available on a physical downlink control channel; and determining that at least one enhanced control channel element is available on an enhanced physical downlink control channel.

The apparatus may be further caused to perform said determining in dependence on at least one second parameter, wherein said at least one second parameter is: I_{PHICH}^{spare} when determining that at least three resource element groups are available on a physical downlink control channel; n_{PHICH}^{CCE} when determining that at least one control channel element is available on a physical downlink control channel; and n_{PHICH}^{ECCE} when determining that at least one enhanced control channel element is available on an enhanced physical downlink control channel.

The apparatus may be further caused to only determine a second plurality of resources for transmission in a subframe fulfilling a predetermined transmission opportunity. The predetermined transmission opportunity may be at least one of: specific subframes of a downlink transmission burst; and subframes falling within a predefined pattern of subframes. The apparatus may be further caused to: transmit an indication of the predetermined transmission opportunity to a user apparatus; and/or receive an indication of the predetermined transmission opportunity from a network apparatus.

The apparatus may be further caused to: transmit acknowledgement data to the at least one user apparatus using the effective control channel only when the predetermined to transmission opportunity is fulfilled; and/or receive acknowledgement data from a network apparatus using the effective control channel only when the predetermined transmission opportunity is fulfilled.

The apparatus may be further caused to transmit acknowledgement data to the at least one user apparatus using the effective control channel only when the feedback delay of providing the acknowledgement data is not less than a minimal processing delay.

The apparatus may be further caused to: map an uplink transmission to one of the first and second plurality of resources using an identification of the uplink transmission. The identification may be a hybrid automatic request process ID. The mapping may comprise implicitly mapping said uplink transmission to one of the first and second plurality of resources. The mapping may comprise: transmitting and/or receiving a signal that indicates a start position of the mapping using said identification of the uplink transmission; and explicitly mapping said uplink transmission to one of the first and second plurality of resources in dependence on the start position.

The apparatus may further be caused to: map at least one of the first plurality of resources to a first group of user apparatuses; map at least one of the second plurality of resources to a second group of user apparatuses; transmit acknowledgement data for at least one of the first group of user apparatuses on the at least one of the first plurality of resources; and transmit acknowledgement data for at least one of the second group of user apparatuses on the at least one of the second plurality of resources; or receive acknowledgement data for at least one of the first group of user apparatuses on the at least one of the first plurality of resources.

The acknowledgement data may be associated with a previous grant-less uplink transmission.

The above-mentioned apparatus may be a network apparatus. The above-mentioned apparatus may be a user apparatus.

According to a third aspect, there is provided a computer program comprising computer executable instructions, which when executed by a computer, cause the computer to perform each of the method steps of the first aspect (i.e. of claim 1). The computer executable instructions may further, when executed by a computer, cause the computer to perform any of the other method features mentioned above.

According to a fourth aspect, there is provided an apparatus comprising: means for determining a first control channel comprising a first plurality of resources in dependence on a first parameter and the downlink bandwidth; means for determining a second plurality of resources available on at least a second control channel; and means for combining the first and second plurality of resources to define an effective control channel for use in signalling acknowledgement data to at least one user apparatus.

The apparatus may further comprise means for receiving a broadcast comprising the first parameter prior to determining the first control channel; or means for storing the first parameter to determine the first control channel, wherein the first parameter is static and is set by a communications protocol.

The at least one second control channel may be at least one of: a physical downlink control channel; and an enhanced physical downlink control channel.

The means for determining a second plurality of resources may comprise at least one of: means for determining that at least three resource element groups are available on a physical downlink control channel; means for determining that at least one control channel element is available on a physical downlink control channel; and means for determining that at least one enhanced control channel element is available on an enhanced physical downlink control channel.

The apparatus may further comprise means for performing said determining in dependence on at least one second parameter, wherein said at least one second parameter is: I_{PHICH}^{spare} when determining that at least three resource element groups are available on a physical downlink control channel; n_{PHICH}^{CCE} when determining that at least one control channel element is available on a physical downlink control channel; and n_{PHICH}^{ECCE} when determining that at least one enhanced control channel element is available on an enhanced physical downlink control channel.

The apparatus may further means for only determining a second plurality of resources for transmission in a subframe fulfilling a predetermined transmission opportunity. The predetermined transmission opportunity may be at least one of: specific subframes of a downlink transmission burst; and subframes falling within a predefined pattern of subframes. The apparatus may further comprise: means for transmitting an indication of the predetermined transmission opportunity to a user apparatus; and/or means for receiving an indication of the predetermined transmission opportunity from a network apparatus.

The apparatus may further comprise means for: transmitting acknowledgement data to the at least one user apparatus using the effective control channel only when the predetermined transmission opportunity is fulfilled; and/or means for receiving acknowledgement data from a network apparatus using the effective control channel only when the predetermined transmission opportunity is fulfilled.

The apparatus may further comprise means for transmitting acknowledgement data to the at least one user apparatus using the effective control channel only when the feedback delay of providing the acknowledgement data is not less than a minimal processing delay.

The apparatus may further comprise: means for mapping an uplink transmission to one of the first and second plurality of resources using an identification of the uplink transmission. The identification may be a hybrid automatic request process ID. The mapping may comprise implicitly mapping said uplink transmission to one of the first and second plurality of resources. The mapping may comprise: transmitting and/or receiving a signal that indicates a start position of the mapping using said identification of the uplink transmission; and explicitly mapping said uplink transmission to one of the first and second plurality of resources in dependence on the start position.

The apparatus may further comprise: means for mapping at least one of the first plurality of resources to a first group of user apparatuses; means for mapping at least one of the second plurality of resources to a second group of user apparatuses; means for transmitting acknowledgement data for at least one of the first group of user apparatuses on the at least one of the first plurality of resources; and means for transmitting acknowledgement data for at least one of the second group of user apparatuses on the at least one of the second plurality of resources; or means for receiving acknowledgement data for at least one of the first group of user apparatuses on the at least one of the first plurality of resources.

The acknowledgement data may be associated with a previous grant-less uplink transmission.

The above-mentioned apparatus may be a network apparatus. The above-mentioned apparatus may be a user apparatus.

According to a fifth aspect, there is provided a method comprising: transmitting uplink data to a network apparatus; and receiving acknowledgement data on at least part of an effective channel in response to the transmitted uplink data, wherein the effective channel comprises a first control channel comprising a first plurality of resources that are defined in dependence on a first parameter and the downlink bandwidth and a second control channel comprising a second plurality of resources.

The receiving may comprise receiving the acknowledgement data on: at least some of the first plurality of resources; or at least some of the second plurality of resources; or at least some of the first and second plurality of resources.

The method may further comprise autonomously determining the effective channel.

The method may further comprise: receiving an indication of the at least part of an effective channel from the network apparatus; and using the received indication to determine when the acknowledgement data is to be received.

The method may further comprise: mapping the uplink transmission to one of the first and second plurality of resources using an identification of the uplink transmission. The identification may be a hybrid automatic request process ID.

The mapping may comprise implicitly mapping said uplink transmission to one of the first and second plurality of resources.

The mapping may comprise: receiving a signal that indicates a start position of the mapping using said identification of the uplink transmission; and explicitly mapping said uplink transmission to one of the first and second plurality of resources in dependence on the start position.

The effective channel may only comprise the second plurality of resources for subframes fulfilling a predetermined transmission opportunity. The predetermined transmission opportunity may be at least one of: specific subframes of a downlink transmission burst; and subframes falling within a predefined pattern of subframes.

The method may further comprise: receiving an indication of the predetermined transmission opportunity from a network apparatus.

The method may further comprise: receiving acknowledgement data from a network apparatus using the effective control channel only when the predetermined transmission opportunity is fulfilled.

According to a sixth aspect, there is provided an apparatus comprising: at least one processor; and at least one memory comprising code that, when executed on the at least one processor, causes to the apparatus to: transmit uplink data to a network apparatus; and receive acknowledgement data on at least part of an effective channel in response to the transmitted uplink data, wherein the effective channel comprises a first control channel comprising a first plurality of resources that are defined in dependence on a first parameter and the downlink bandwidth and a second control channel comprising a second plurality of resources.

The apparatus may be caused to receive by receiving the acknowledgement data on: at least some of the first plurality of resources; or at least some of the second plurality of resources; or at least some of the first and second plurality of resources.

The apparatus may be caused to autonomously determining the effective channel.

The apparatus may be further caused to: receive an indication of the at least part of an effective channel from the network apparatus; and use the received indication to determine when the acknowledgement data is to be received.

The apparatus may be further caused to: map the uplink transmission to one of the first and second plurality of resources using an identification of the uplink transmission. The identification may be a hybrid automatic request process ID.

The mapping may comprise implicitly mapping said uplink transmission to one of the first and second plurality of resources.

The mapping may comprise: receiving a signal that indicates a start position of the mapping using said identification of the uplink transmission; and explicitly mapping said uplink transmission to one of the first and second plurality of resources in dependence on the start position.

The effective channel may only comprise the second plurality of resources for subframes fulfilling a predetermined transmission opportunity. The predetermined transmission opportunity may be at least one of: specific subframes of a downlink transmission burst; and subframes falling within a predefined pattern of subframes.

The apparatus may be further caused to: receive an indication of the predetermined transmission opportunity from a network apparatus.

The apparatus may be further caused to: receive acknowledgement data from a network apparatus using the effective control channel only when the predetermined transmission opportunity is fulfilled.

According to a seventh aspect, there is provided an apparatus comprising: means for transmitting uplink data to a network apparatus; and means for receiving acknowledgement data on at least part of an effective channel in response to the transmitted uplink data, wherein the effective channel comprises a first control channel comprising a first plurality of resources that are defined in dependence on a first parameter and the downlink bandwidth and a second control channel comprising a second plurality of resources.

The means for receiving may comprise means for receiving the acknowledgement data on: at least some of the first plurality of resources; or at least some of the second plurality of resources; or at least some of the first and second plurality of resources.

The apparatus may comprise means for autonomously determining the effective channel.

The apparatus may further comprise: means for receiving an indication of the at least part of an effective channel from the network apparatus; and means for using the received indication to determine when the acknowledgement data is to be received.

The apparatus may further comprise means for: mapping the uplink transmission to one of the first and second plurality of resources using an identification of the uplink transmission. The identification may be a hybrid automatic request process ID.

The mapping may comprise implicitly mapping said uplink transmission to one of the first and second plurality of resources.

The mapping may comprise: receiving a signal that indicates a start position of the mapping using said identification of the uplink transmission; and explicitly mapping said uplink transmission to one of the first and second plurality of resources in dependence on the start position.

The effective channel may only comprise the second plurality of resources for subframes fulfilling a predetermined transmission opportunity. The predetermined transmission opportunity may be at least one of: specific subframes of a downlink transmission burst; and subframes falling within a predefined pattern of subframes.

The apparatus may further comprise: means for receiving an indication of the predetermined transmission opportunity from a network apparatus.

The apparatus may further comprise: means for receiving acknowledgement data from a network apparatus using the effective control channel only when the predetermined transmission opportunity is fulfilled.

According to an eighth aspect, there is provided a computer program comprising computer executable instructions, which when executed by a computer, cause the computer to perform the method steps of any of claims 19 to 30.

### DESCRIPTION OF FIGURES

Embodiments will now be described, by way of example only, with reference to the accompanying Figures in which:

FIG. 1 shows a schematic diagram of an example communication system comprising a plurality of base stations and a plurality of communication devices;

FIG. 2 shows a schematic diagram of an example mobile communication device;

FIG. 3 is a flow diagram of operations that may be performed by an apparatus;

FIGS. 4 to 9 illustrate different resource element principles in accordance with different examples; and

FIG. 10 is a flow diagram of operations that may be performed by an apparatus.

### DETAILED DESCRIPTION

In general, the following disclosure relates to providing at least one mechanism for providing acknowledgement data (such as positive acknowledgements and negative acknowledgements) in a downlink transmission for transmissions made in the uplink. The following disclosure has particular relevance to those transmissions made in an uplink transmission slot by an apparatus when the uplink transmission slot was not scheduled to the apparatus for transmission. Such transmissions may be called uplink “grant-less” transmissions, uplink “grant-free” transmissions, uplink contended-access transmissions, uplink contention-based transmissions, and uplink contention-based access transmissions.

In further, detail, there are provided mechanisms for determining a channel over which acknowledgement data may be transmitted on the downlink. Further, there are provided mechanisms for determining a timeslot in which the channel may be provided. Further, there are provided mechanisms for determining which resource within the timeslot is used to convey acknowledgement data for a specific user.

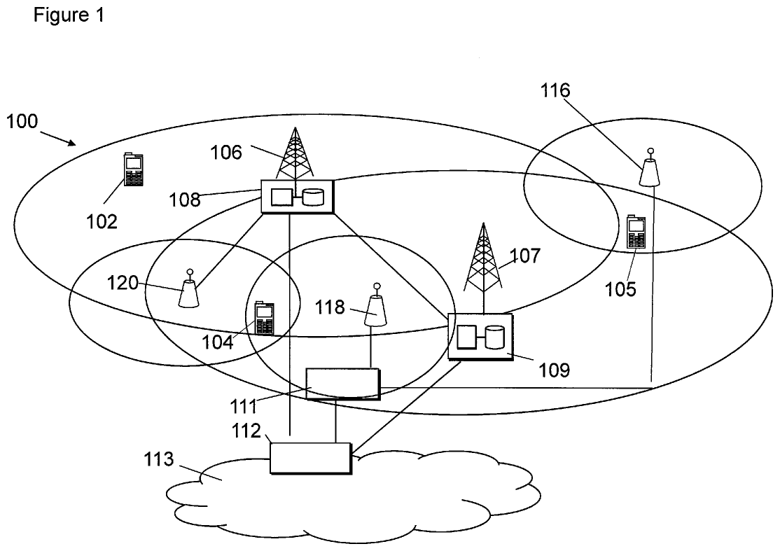

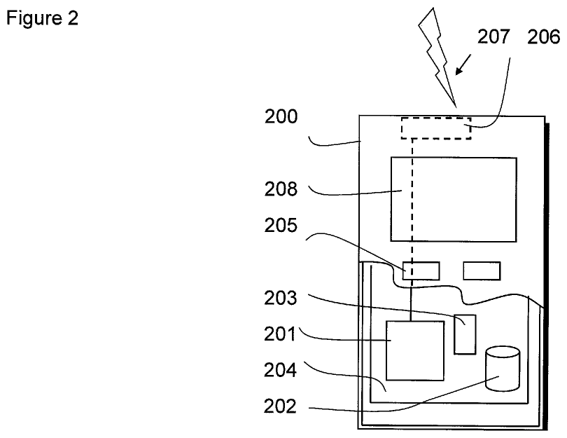

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user apparatus (UE) 102, 104, 105 are provided wireless access via at least one base station or similar wireless transmitting and/or receiving node or point. A base station is referred to as an eNodeB (eNB) in LTE, and may be referred to more generally as simply a network apparatus or a network access point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each user apparatus is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In an LTE system, radio resource control (RRC) is defined to be a sublayer of radio interface Layer 3 that exists in the control plane only, and which provides information transfer service to the non-access stratum (see 3GPP Technical Specification Group Services and System Aspects 21.905). RRC is a protocol layer between a user apparatus and an eNB, and is in charge of, for example, paging the user apparatus when traffic comes, establishing/maintaining or release of radio bearers (establishing an RRC connection between user apparatus and eNB), user apparatus mobility, user apparatus measurement configuration and user apparatus reporting configuration, etc. RRC is responsible for controlling the configuration of radio interface Layers 1 and 2.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, base stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user apparatus (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2, the transceiver apparatus is designated schematically by block 206. The transceiver apparatus 206 may be provided, for example, by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) or LTE Advanced Pro of the Universal Mobile Telecommunications System (UMTS) radio-access technology. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Recently, developments have been made in Multefire. Multefire is a system based on LTE-like radio access technology that is designed for stand-alone deployments in the unlicensed spectrum.

In a Multefire system (and more generally with LTE stand-alone operation in an unlicensed band), communications between the user apparatus and a network apparatus is subject to the outcome of channel clearance assessment. In other words, communications between the user apparatus and a network apparatus may only be performed (at least initially) when a channel being used for transmissions between the two entities has not been used for a predetermined time immediately preceding the transmission, or is not currently being used at the point in time at which an communication is initiated. In particular, a listen-before-talk (LBT) procedure may be implemented. Hence, any message exchanged between a network apparatus, such as an eNB, and a user apparatus is subject to LBT/the channel being clear.

This is different to networks operating on licensed spectrum(s), such as some legacy LTE systems. This is because the communication devices in such licensed spectrums are always assigned/scheduled resources for use by the communication devices in accessing the medium. In legacy LTE, the transmission of control messages is always guaranteed, regardless of a level of interference on the communication channel. Therefore, problems arising from accessing the medium due to a LBT procedure failing to get access to a free/clear channel was never an issue in such systems.

In contrast, in systems like Multefire, that operate on an unlicensed spectrum, strict coexistence regulations needing to be fulfilled, such as LBT succeeding prior to any message or data being sent in either the uplink or the downlink. Only if the channel is clear will data be transmitted. Similar issues may affect other types of communication systems. For example, in other systems, there may be only one-way LBT, meaning that only one end of the transmission link needs to do LBT, but still the availability of the radio channel would not be guaranteed.

In the following, the transmission of signals on unlicensed spectrum, subject to Listen-Before-Talk rules or the like, is considered. The described mechanisms may thus relate to MulteFire Rel. 1.1 as well as to 3GPP LTE Licensed Assisted Access (LAA) enhancements in Rel-15, and offer particular support for autonomous uplink (or grant-less uplink, GUL) transmissions in MulteFire as well as in LAA.

The motivation of grant-less uplink transmission is mainly driven by two use cases. One use case is to reduce latency related to uplink transmissions for new data arriving in the user apparatus buffer. In this case, the grant-less uplink transmission users may transmit uplink data in an autonomous manner i.e. without waiting to be scheduled resources for transmitting this data. Once the data of a user arrives in the buffer, it may thus be transmitted immediately, without waiting for transmission of scheduling request and without waiting for a network apparatus to schedule or send a resource grant for transmission if the uplink clear channel assessment is successful. This leads to the prioritization of using grant-less uplink transmissions for uplink transmission on unlicensed spectrum access, especially for small packet transmission. The other use case is based on maintaining uplink transmission opportunities for cases in which the network apparatus fails to obtain the channel through the clear channel access procedure, and as a consequence the user apparatus is unable to have a scheduling grant for its uplink transmissions. For such cases, the grant-less uplink would ensure that the user apparatus would still be able to transmit its data towards the network apparatus.

In the complex wireless communication environment, Hybrid-automatic-repeat-request (HARQ) retransmission has been used as a tradeoff between transmission efficiency and reliability. HARQ retransmissions utilise a feedback procedure in which acknowledgement data (i.e. positive and/or negative acknowledgements) associated to uplink transmissions made to a network apparatus by a user apparatus are fed back by the network apparatus to the user apparatus. The provision of a negative acknowledgement (and/or the lack of provision of a positive acknowledgement) for a particular uplink transmission may be used by the user apparatus to retransmit the data transmitted on the particular uplink transmission. HARQ retransmissions also utilise some form of error correction, such as forward error correction codes, to reduce the amount of retransmissions requested.

The inventors have realised that introducing HARQ retransmission to grant-less uplink transmission operation may enable an increase in the uplink spectral efficiency. For example, for grant-less uplink transmissions on unlicensed bands, the interference fluctuation and transmission collision situation may increase over time, which could lead to incorrect data detection by the network apparatus. Therefore, HARQ retransmission is a useful tool for ensuring the reliability of grant-less uplink transmission and/or coverage.

It is understood that although the first uplink transmission is performed in an autonomous manner for grant-less uplink transmission, the retransmission of the uplink data may be performed based on either a new grant-less uplink transmission and/or on a scheduled/granted uplink resource. However, regardless of which retransmission procedure is adopted for grant-less uplink retransmission, it is necessary to report the acknowledgement data to grant-less uplink transmitting user apparatuses so as to monitor whether or not the grant-less uplink transmission procedures are operating correctly. The use of acknowledgement data feedback for grant-less/autonomous retransmission is described as below.

For autonomous retransmission, grant-less uplink user apparatuses are configured to buffer data until an ACK (positive acknowledgement) or NACK (negative acknowledgement) is received from the serving network apparatus (i.e. the network apparatus that is providing an access point to a network providing a communication service to the user apparatuses). In this case, the retransmission may be triggered for a grant-less uplink user apparatus only if a negative acknowledgement is received, and the user apparatus is configured to either transmit on predefined resources associated to the NACK indication or to transmit using the next available grant-less uplink opportunity.

For scheduled retransmission, the retransmission of the previously transmitted uplink data is scheduled with an uplink grant if the serving network apparatus fails in data decoding. However, the probability is very high that the serving network apparatus will miss detection of the grant-less uplink transmission due to increased interference fluctuation and collision on unlicensed bands relative to licensed bands. In this case, no assignment/scheduling of resources may be made and no explicit indication of a missed transmission will be provided to the transmitting grant-less uplink user apparatus. If the serving network apparatus doesn't report the receiving status to the transmitting grant-less uplink user apparatus, the grant-less uplink user apparatus assumes that the missing grant-less uplink transmission is received by the receiver/serving network apparatus after a time window, and then cleans the buffer.

For MulteFire1.0 and LAA, both the first transmission and subsequent retransmissions are based on uplink scheduling grant. If the serving network apparatus receives the uplink scheduled data incorrectly or timeout after sending uplink scheduling grant, the serving network node is configured to re-schedule the user apparatus for retransmission through the uplink grant mechanism. If this re-scheduling does not occur, the serving network apparatus would not send acknowledgement data to the scheduled user apparatus. Consequently, the user apparatus would assume that the transmitted uplink data was received correctly and clean its' buffer. For such an operation, the acknowledgement data feedback is no longer required for uplink HARQ, and thus acknowledgement data feedback associated with the physical uplink shared channel transmissions is no longer supported in MulteFire1.0 and LAA.

The inventors have thus realised that the current specifications of MulteFire1.0 and LAA do not support the transmission of acknowledgement data feedback for normal scheduled uplink transmissions. The following thus relates to the transmission of acknowledgement data for grant-less uplink transmissions. However, it is understood that similar principles may be applied in scheduled uplink transmission-based system.

In licensed bands, the Physical Hybrid-ARQ Indicator Channel (PHICH) in the downlink is used to carry HARQ acknowledgement data (ACK/NACK) for uplink data transfers in LTE.

A PHICH is carried by three Resource Element Groups (REGs). Eight PHICHs can share the same set of REGs, and are differentiated from each other by respective orthogonal cover codes. PHICHs that share the same physical resources are called a PHICH group, i.e. a PHICH group supports 8 PHICHs at most. Consequently, a specific PHICH is identified by a pair of parameters (n_{PHICH}^{group}, n_{PHICH}^{seq}) : the PHICH group number (n_{PHICH}^{group}) and the orthogonal sequence index within the group (n_{PHICH}^{seq}).

The actual number of PHICH groups forming the overall PHICH channel can be derived from the downlink bandwidth and a parameter known as N_{g} in current LTE nomenclature. Both of these parameters are broadcast in the Master Information Block (MIB) transmission from the network apparatus to the user apparatus. The information element specifying how a PHICH configuration is related to N_{g} (i.e. PHICH resource) for regular LTE is defined in TS 36.331, and reproduced below:

PHICH-Config information element

-- ASN1START

| | |
|---|---|
| PHICH-Config ::= | SEQUENCE { |

| | |
|---|---|
| phich-Duration | ENUMERATED {normal, extended}, |

| | |
|---|---|
| phich-Resource | ENUMERATED {oneSixth, half, one, |

two}

}
-- ASN1STOP

3GPP specifications also provide a formula for determining a number of PHICH groups, (see 3GPP TS 36.211 section 6.9). This formula is reproduced as equation (1) below:

$${N}_{PHICH}^{g r o u p} = \{ \begin{matrix}⌈ {N}_{g} ( {N}_{R B}^{D L} \text{/} 8 ) ⌉ & for normalcyclicprefix \\ 2 \cdot ⌈ {N}_{g} ( {N}_{R B}^{D L} \text{/} 8 ) ⌉ & for extendedcyclicprefix\end{matrix} \qquad ( 1 )$$

where N_{g}∈{⅙, ½, 1, 2} is provided by higher layers and conveyed to a user apparatus via master information block signalling (as mentioned above). The index n_{PHICH}^{group} ranges from 0 to N_{PHICH}^{group}−1.

As mentioned above, each PHICH carries HARQ acknowledgement data for uplink data transfers. A user apparatus receiving this acknowledgement data needs to know where to look for its PHICH to retrieve its corresponding acknowledgement data. In the time domain, if the uplink transmission occurs in subframe n, the corresponding PHICH will be in subframe n+k_{PHICH}, where (in current LTE systems) k_{PHICH} is always 4 for frequency division duplex operations, and where k_{PHICH} is given in 3GPP TS 36.213 table 9.1.2-1 for time division duplex operation. In the frequency domain, the location of the corresponding PHICH is indicated by the uplink resource allocation with downlink control information format 0. In this case, the specific PHICH assigned for a particular user (defined by a PHICH group number and an orthogonal sequence index within the group) is derived from the lowest uplink physical resource block index in the first slot of the corresponding physical uplink shared channel transmission, as well as the demodulation reference signal cyclic shift. The detailed method for determination of PHICH resource is defined in 3GPP TS 36.213 section 9.1.2.

To enable grant-less uplink retransmission, the inventors have realised that it may be useful to reuse the PHICH-based framework for acknowledgement data feedback. That would have several different advantages

For example, the grant-less uplink retransmissions may reuse the same physical channel structure, channel coding and multiplexing approach for PHICH as legacy PHICH in LTE (i.e. the term legacy PHICH will be used here in to denote those PHICH resources defined in the specifications mentioned above).

Further, the PHICH resource may continue to be identified by the index pair (n_{PHICH}^{group}, n_{PHICH}^{seq}), which is adopted to carry the HARQ acknowledgements for uplink data transfers.

However, several technical challenges still exist when implementing the PHICH-based framework described above in a grant-less uplink transmission scheme instead of in a grant-based uplink transmission scheme.

First, the inventors have realised that the way in which resources are configured/assigned for use in reporting acknowledgement data may need to be changed for grant-less uplink transmissions. For example, in current discussions, in MulteFire1.0 the parameter N_{g} is no longer broadcast in the Master Information Block. Therefore, the MulteFire system does not dynamically configure the PHICH resource (in contrast to the legacy grant-based systems). It is likely, however, that MulteFire systems may instead reserve a minimum PHICH resource configuration (i.e. N_{g}=⅙), based on the PHICH resource configuration detailed above for grant-based systems. Another option would be to re-introduce the N_{g} parameter in the MasterinformationBlock-MF information element, which would allow for some flexibility of the PHICH resource allocation. However, this is not guaranteed and it is assumed throughout the following that the PHICH resources are either configured through a hard-coded parameter (N_{g}) in the operating communication specification between the network apparatus and the user apparatus, as mentioned above or configured dynamically through signalling from the network apparatus to the user apparatus.

To exemplify this issue, it is assumed that the downlink channel bandwidth is 20 MHz. In this case, there will be a total of three PHICH groups available for frequency division duplex-style operation. The total number of PHICHs supported per subframe would then be 24 PHICHs. It is assumed that the bitmap feedback of acknowledgement data is adopted for grant-less uplink transmission with 8 HARQ processes per user as example. In this case, the PHICH resources available will only support three grant-less uplink user apparatuses. Due to limited number of REGs for PHICH, the number of supportable grant-less uplink user apparatuses may be fewer for uplink transmission. In this case, the capacity of PHICH needs to be extended to support more users for grant-less uplink transmission. Due to backward compatibility with MulteFire 1.0, the inventors have realised that it may be challenging to re-introduce a variable PHICH configuration on the physical broadcast channel. Therefore, the inventors have realised that some other mechanisms may be needed to account for variability in users for extending the capability of PHICH.

Secondly, as the HARQ timing for physical uplink shared channel and the corresponding PHICH is fixed in current grant-based LTE systems, systems that do not have this mechanism (such as those that must wait for a clear channel prior to transmitting) require a new mechanism for determining when to provide HARQ feedback. On the unlicensed bands discussed above, the transmission of PHICH would thus be subject to the outcome of listen before talk mechanisms succeeding before any transmission is made. This may result in the actual acknowledgement data feedback of grant-less uplink transmissions being deferred until the serving network apparatus is able to implement a downlink channel. Consequently, the inventors have realised that the HARQ timing for GUL physical uplink shared channel on the PHICH should be modified to support acknowledgement data feedback of GUL transmission on the unlicensed band.

Thirdly, in current grant-based LTE systems, the specific PHICH resource is implicitly indicated by the uplink resource allocation of the corresponding physical uplink shared channel transmission in LTE. As there is no uplink grant in the presently considered case, the resource allocation of physical uplink shared channel transmission in the present case is generally configured in a semi-static way. Since the same resource would be used for grant-less uplink transmission of multiple HARQ processes, it is possible that there will be a collision of PHICH resources used for acknowledgement data feedback of HARQ processes if the grant-based mechanism was also applied to the grant-less transmission system. The inventors have thus realised that the linkage between PHICH resource and GUL transmission should also be redefined.

Based on the analysis above, the inventors are proposing various mechanisms for addressing these issues. These are described below, with reference to particular examples. However, it is understood that these examples are merely used to illustrate how the broader described principles may be applied in a communication system, and are not intended to be limiting. They may also be applied individually as well as in combination.

As a first example, a mechanism for enabling the sending of acknowledgement data for a variable number of users is considered.

In the above, a description of how an existing system configures PHICH resources has been described. Hereinafter, this existing system configuration is labelled as legacy PHICH resources (regardless of whether the parameter N_{g} is set by an operating communication protocol or is variable and set dynamically during communication between the network apparatus and the user apparatus). Besides the legacy PHICH resources, the network apparatus may be configured to create/configure additional resource(s) for PHICH usage i.e. for providing acknowledgement data. In other words, the presently described system is arranged to provide an effective PHICH, which consists of both legacy PHICH resources and spare resources from channels that are primarily designated for transmission of data other than acknowledgement data.

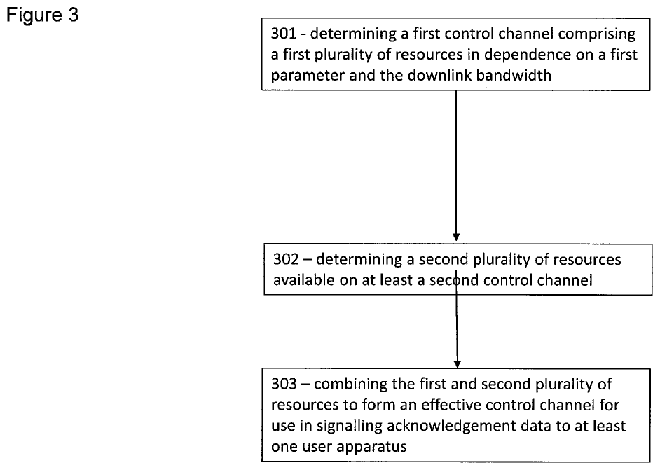

Thus, there may be provided a network apparatus configured to operate in accordance with operations described in relation to FIG. 3.

At 301, the network apparatus is configured to determine a first control channel comprising a first plurality of resources in dependence on a first parameter and the downlink bandwidth. The first parameter may be, or may take a similar role to, N_{g}. The first control channel may comprise a legacy PHICH channel, with the first plurality of resources corresponding to the legacy PHICH resources. It is understood that these legacy PHICH resources may, however, have a semi-static value of N_{g}. In other words, the value of N_{g} may not be signalled to the user apparatus on a regular basis. In other words, the value of N_{g} may be set by the operating communication protocol.

Thus, the first plurality of resources may be labelled as Legacy PHICH resource N_{PHICH, legacy}^{group}, which corresponds to an available number of PHICH groups that is determined by the downlink bandwidth and the parameter N_{g}. For MulteFire, a fixed PHICH resource (e.g. N_{g}=⅙) may be reserved. Alternatively, a system broadcasted parameter N_{g} (broadcasted by the network apparatus) may be used. Both of these potential options are discussed above.

At 302, the network apparatus is configured to determine a second plurality of resources available on at least a second control channel. More specific details on how this may be achieved, and what resources may be allocated, is discussed below, using existing LTE systems/terminology as an example.

At step 303, the network apparatus is configured to combine the first and second plurality of resources to form an effective control channel for use in signalling acknowledgement data to at least one user apparatus. Thus, by forming an effective control channel for this purpose, an increased number of user apparatuses may receive acknowledgement data, relative to the legacy PHICH case.

The network apparatus may use this effective control channel to signal acknowledgment data to the at least one user apparatus. The at least one user apparatus, in response to receiving the signalled acknowledgment data, may determine to retransmit the previously transmitted data to which the acknowledgment data relates. This retransmission may be made on a grant-less uplink transmission, such as the next available grant-less uplink transmission. This retransmission may be made on a scheduled uplink transmission. In this latter case, the scheduling of the uplink transmission may be set by the format of the transmitted acknowledgment data, such that the location of the acknowledgment data causing the retransmission determines when the retransmission is made in the uplink.

The additional PHICH resource(s) may be spare resources having a size that is less than a Control Channel Element (CCE) but not less than a PHICH resource element group in a physical downlink control channel region. A physical downlink control channel comprises a message (the downlink control information message) having a format that varies in dependence on resources being assigned in the downlink control information message. Allocation of resources on the physical downlink control channel is performed using control channel elements. One control channel element consists of nine continuous resource element groups in LTE. One resource element group consists of four resource elements, where a single resource element represents the minimum resource unit in the LTE system (i.e. currently one orthogonal frequency division multiple access symbol in the time domain and one sub-carrier in the frequency domain). The currently defined physical downlink control channel uses resources available in the first n OFDM symbols of the physical downlink control channel. Therefore, the number of control channel elements present to transmit the control information on the physical downlink control information varies on a parameter n (defined by the network), the total bandwidth of the system and the number of antenna ports present.

The additional PHICH resource(s) may be a set of configured control channel elements (CCEs) in the Physical downlink control channel (PDCCH) region; or the additional PHICH resource(s) may be a set of configured Enhanced control channel elements (ECCEs) in the Enhanced Physical downlink control channel (EPDCCH) region.

The additional PHICH resource(s) may be pre-defined by the operating communication protocol that defines the communications between the network apparatus and the user apparatus. The additional PHICH resource(s) may be semi-statically configured via radio resource control signalling from the network. By this, it is meant that radio resource control signalling may be used infrequently throughout operation to change the additional PHICH resource(s) that are configured.

There are a variety of ways in which the second plurality of resources (also known herein as “additional resources”) may be configured. For example, in LTE-based systems, the configuration of additional PHICH resource may contain a usage indicator of spare physical downlink control channel resources, a number of control channel elements in the physical downlink control channel or/and a number of enhanced control channel elements in the enhanced physical downlink control channel region for use as additional PHICH resources. These options are discussed further below. The physical downlink control channel and the enhanced physical downlink control channel are both channels that have been defined in various LTE releases (the enhanced physical downlink control channel was introduced in Release 11).

Spare physical downlink control channel resource N_{PHICH, SPARE}^{group}: The network apparatus may be configured to generate an indicator of the usage of spare PHICH resources, I_{PHICH}^{spare}. If I_{PHICH}^{spare} is set to 1, the spare physical downlink control channel resource element groups (which is less than nine resource element groups) may be used as PHICH resources. Otherwise, (i.e. if the indicator indicates that the spare resource element groups on this channel would not be acted as PHICH usage), N_{PHICH, SPARE}^{group}=0. The number of available spare resource element groups in the physical downlink control channel may be determined by the system bandwidth, the number of orthogonal frequency division multiple access symbols for the physical downlink control channel, and the antenna port configuration of the cell-specific reference signal (CRS) transmitted by the network apparatus on the downlink. In this case, the network apparatus may be configured to determine whether there are at least three resource element groups but less than one control channel element available on a physical downlink control channel, in order to determine if there are any N_{PHICH, SPARE}^{group} available.

Physical downlink control channel resource N_{PHICH, CCE}^{group}: These resources relate to the number of control channel elements that are configured for PHICH usage in the system. If n_{PHICH}^{CCE} may doesn't equal 0, the last n_{PHICH}^{CCE} control channel elements in the at least one of the common search space and the UE-specific search space of the physical downlink control channel may be used as PHICH resource(s). The term “search space” is used in this context to denote a collection of control channel elements in which a control channel may be found. The common search space denotes those control channel elements in which control channels for a plurality of user apparatuses may be found. The UE-specific search space denotes those control channel elements in which at least one control channel for a single specific user may be found. Depending on the operating communication system, there may be a common search space or a UE-specific search space or both a common search space and a UE-specific search space. Each physical downlink control channel resources may include 3×n_{PHICH}^{CCE} PHICH groups, i.e. each control channel element is implicitly mapped into three PHICH groups, each of which consists of three resource element resource groups.

Enhanced physical downlink control channel resource N_{PHICH, ECCE}^{group}: if n_{PHICH}^{ECCE} doesn't equal 0, the last n_{PHICH}^{ECCE} of control channel elements in the common/UE-specific search space of the enhanced physical downlink control channel may be used as PHICH usage.

Unlike a control channel element of the non-enhanced channel type (i.e. of the physical downlink control channel), which always consists of 36 available resources, the number of available resource elements in an enhanced control channel element (n_{ECCE}^{RE}) varies depending on the presence of other signals, such as reference signals and the legacy downlink control region. As one example, it is proposed that a PHICH group is mapped into four enhanced resource element groups of one enhanced control channel element and occupies three resource elements of an enhanced resource element group. Furthermore, the number of PHICH resources available per enhanced control channel element (N_{PHICH,ECCE}^{group}) is calculated based on the following function:

N_{PHICH, ECCE}^{group}=└n_{ECCE}^{RE}/12┘ (2)

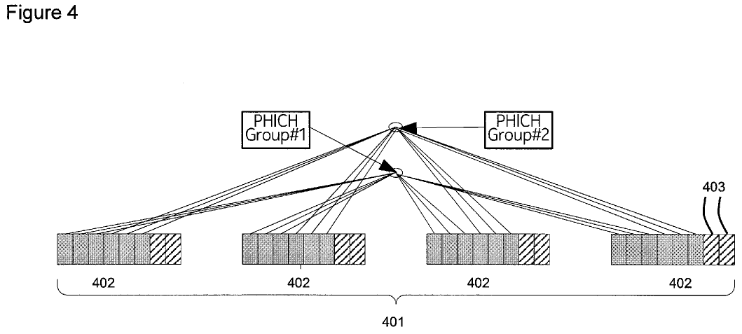

An example of this is illustrated with respect to FIG. 4, which depicts a mapping function between a PHICH group and an enhanced control channel element.

As shown in FIG. 4, an enhanced channel control element 401 is comprised of four enhanced resource element groups 402. Each enhanced resource element group consists of eight resource elements 403. As the mapping is executed such that three resource elements from each resource element group are mapped to a respective PHICH group, this means that two PHICH groups may be mapped onto a single enhanced control channel element, with eight resource elements remaining unmapped for PHICH purposes.

It is understood that the user apparatus may also execute some functions in relation to receiving this acknowledgment data. These operations may be the same as those described in relation to FIG. 3, as the user equipment will similarly be required to determine what the effective control channel will be for receiving acknowledgement data. In contrast to the network apparatus, which will transmit acknowledgement data on the determined effective control channel, the user apparatus will receive acknowledgment data on at least some of the determined effective control channel (as some of the acknowledgment data on some resources may be intended for other user apparatuses). In response to this received acknowledgment data, the user apparatus may be configured to retransmit the data to which at least part of the acknowledgement data relates. This retransmission may be made in accordance with the principles discussed above.

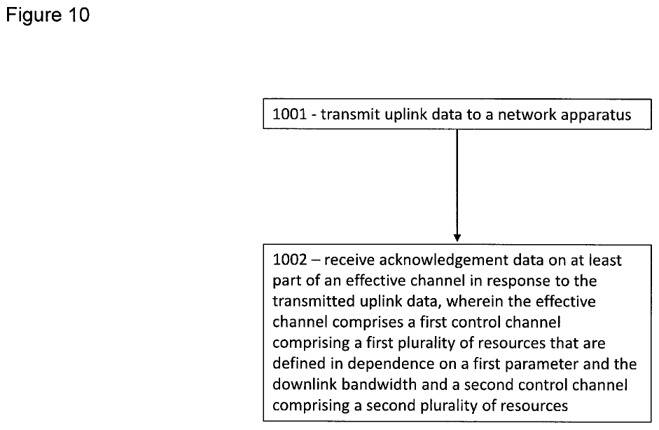

It is also understood that a user apparatus may not necessarily determine the full extent of the effective control channel (i.e. there user apparatus may not autonomously determine the effective control channel). In this case, the user apparatus may be configured to perform actions described in relation to FIG. 10.

At 1001 of FIG. 10, the user apparatus is configured to transmit uplink data to a network apparatus.

At 1002, the user apparatus is configured to receive, from the network apparatus, acknowledgement data on at least part of an effective channel in response to the transmitted uplink data, wherein the effective channel comprises a first control channel comprising a first plurality of resources that are defined in dependence on a first parameter and the downlink bandwidth and a second control channel comprising a second plurality of resources.

The following operations apply in respect of both the case when the user apparatus operates in accordance with FIG. 3, and when the user apparatus operates in accordance with FIG. 10).

The receiving of acknowledgement data by the receiver may comprise receiving the acknowledgement data on: at least some of the first plurality of resources; or at least some of the second plurality of resources; or at least some of the first and second plurality of resources. This may be of particular use if a user apparatus forms part of a group of user apparatuses that are assigned to a common set of resources. For example, a first group of user apparatuses may be assigned to a set of resources for providing acknowledgement data whilst a second (different) group of user apparatuses are assigned a different set of resources for providing acknowledgement data. The assigned sets of resources may thus be considered as pooled. The different sets of resources may be provided on different “real” control channels, such that the first group of apparatuses operate using a pool of resources on the PHICH, whilst the second group of apparatuses operate using a pool of resources on the physical downlink control channel or the like. It is understood that a group may consist of only one user apparatus. In this case, the assignment is considered to be user-specific rather than being to a group. It is further understood that a group may consist of more than one user apparatus. The number of apparatuses in each group may be set (or be limited) by the operating communication protocol.

Further, a set of resources assigned to a particular group of users may be shared by that group of users in a defined way. For example, at any one time, acknowledgment data for only part of the particular group of users may actively be transmitted. In other words, the group of users may share the set of resources in a time-sharing manner. The determination of which users of the group of users are to receive acknowledgment data may be carried out in any one of a plurality of different ways. One way is to use a randomisation function (as detailed further below). However, it is understood that this is merely an example, and other mechanisms are also possible.

The user apparatus may be further configured to receive an indication of the at least part of an effective channel from the network apparatus. The user apparatus may be configured to use the received indication to determine when the acknowledgement data is to be received.

An example of this is also described below in relation to how the network apparatus is configured to determine which resources should be used to provide acknowledgement data for specific users. In particular, the user apparatus may be configured to map the uplink transmission to at least one of the first and second plurality of resources using an identification of the uplink transmission. The identification may be a hybrid automatic request process ID (described further below).

The mapping may comprise implicitly mapping said uplink transmission to one of the first and second plurality of resources. By this, it is meant that the mapping is performed based on parameters statically (or semi-statically) defined by the operating communication protocol. Alternatively, the mapping may utilise a mapping mechanism based on an explicitly received indication. In this case, the user apparatus is configured to receive a signal that indicates a start position of the mapping using said identification of the uplink transmission. The user apparatus is further configured to explicitly map said uplink transmission to one of the first and second plurality of resources in dependence on the start position.

The user apparatus may determine which resources may be used for receiving the acknowledgment data with reference to a configuration policy. The configuration policy may define the pool of resources to be used for PHICH signalling. The configuration policy may define an assignment of PHICH resources from the pool to a specific user apparatus. Further details on how this may be performed is detailed below. The configuration policy may be pre-defined by a communication protocol and/or network operator. The configuration policy may be transmitted to the user apparatus from the network apparatus using the radio resource control signalling layer. By this, it is meant that the radio resource control signalling layer comprises an indication that conveys the configuration policy to a receiving user apparatus.

Thus, if the user apparatus performs grant-less uplink transmission in subframe n, then the user apparatus will attempt to receive the acknowledgement feedback for that transmission in the PHICH resource pool with the timing timing n+k_{PHICH}, in which
k_{PHICH} is not less than the minimal processing delay, e.g., 4 ms, and
k_{PHICH} is determined by the pre-configured transmission opportunity of PHICH in the PHICH configuration discussed further below).

Information that may form part of the configuration policy includes:
The usage indicator of any spare PHICH resource I_{PHICH}^{spare};
The number of control channel elements in physical downlink control channel configured for PHICH purposes n_{PHICH}^{CCE}; and
The number of enhanced control channel elements in enhanced physical downlink control channel configured for PH ICH purposes n_{PHICH}^{ECCE}.

These are defined/discussed further above.

Consequently, according to the above-described specific example, the total number of PHICH groups in the resource pool can be calculated using equation 3:

N_{PHICH, Total}^{group}=N_{PHICH, Legacy}^{group}+N_{PHICH, SPARE}^{group}+N_{PHICH, CCE}^{group}+N_{PHICH, ECCE}^{group} (3)

Any and all of these additional resources may be configured, depending on the exact configuration of the system being considered.

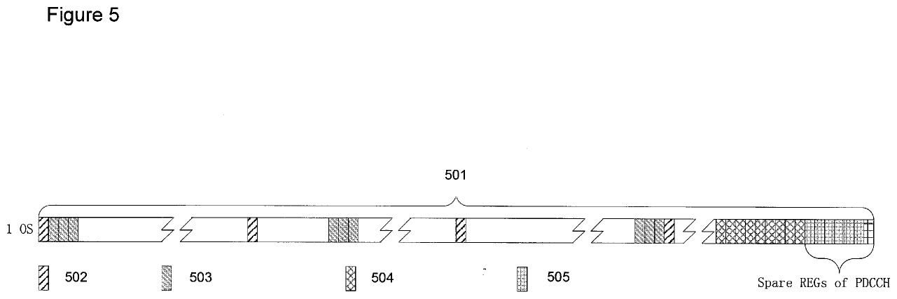

An example in FIG. 5 illustrates the configuration principle of PHICH resource pool.

This example assumes a 20 MHz system bandwidth in which three PHICH groups are available in the legacy PHICH region.

FIG. 5 illustrates a system bandwidth 501 that comprises a plurality of different types of resource element groups 502, 503, 504, 505. Resource element group 502 corresponds to resource element groups used for the physical control format indicator channel (PCFICH—another type of control channel used in the downlink). Resource element group 503 corresponds to resource element groups that are configured as per the legacy PHICH case, using parameter N_{g}. Resource element group 504 corresponds to resource element groups that are spare in the physical downlink control channel. Resource element group 505 corresponds to the last control channel elements available in the physical control channel search space.

FIG. 5 relates to an example system in which there is one orthogonal sequence for the physical downlink control channel and two cell-specific antenna ports (i.e. 7 REGs could be spare for PDCCH, i.e. mod (100 REGs for 20 MHz−4 REGs for PCFICH−9 REGs for legacy PHICH−100 REGs for CRS, 9 REGs of a CCE)=7 REGs. As I_{PHICH}^{spare}=1, two PHICH groups could be available from the spare physical downlink control channel resource. As n_{PHICH}^{CCE}=1 and n_{PHICH}^{ECCE}=0, the last CCE in the configured physical downlink control channel search space are acted as PHICH usage, i.e. three PHICH groups could be available for PHICH usage.

In combination with or separate to the above, there is provided a second mechanism for mitigating a problem that arises when implementing the PHICH system into a grant-less transmission system.

This second mechanism relates to enabling a user apparatus to determine a subframe in which the acknowledgement data is to be provided and to enabling a network apparatus to determine a subframe in which to transmit acknowledgement data for uplink transmissions. As in the previous mechanism, after determining a subframe, the network apparatus may be configured to transmit the acknowledgement data in this determined subframe whilst the user apparatus may be configured to receive acknowledgement data in this determined subframe. The user apparatus may be configured to make a retransmission as described above in response to receiving the acknowledgement data in the determined subframe.

In particular, the second mechanism defines a transmission opportunity for PHICH resources (which may be legacy and/or additional resources). This transmission opportunity may be indicated as an offset and/or transmission pattern relative to a specified subframe of a downlink burst (e.g. relative to the first subframe or the last subframe). By only presenting PHICH resources in a specific subframe of a downlink burst, the PHICH overhead may be reduced, which improves the efficiency of the system.

Therefore, each of the network apparatus and the user apparatus may be configured to apply, to a downlink transmission, a pattern and/or offset to the downlink transmission, relative to the first subframe of the downlink transmission to determine a location of PHICH resources. The pattern and/or offset may be directly signalled using radio resource control signalling from the network apparatus to the user apparatus, and/or be pre-defined, or/and implicitly indicated by a randomization function in order to enable each grant-less uplink user apparatus circularly using PHICH resource.

In an example, the above-mentioned additional PHICH resources per user apparatus are only reserved in specific time instances (e.g. the first/end downlink subframe in the downlink burst, or the odd/even downlink subframes in the downlink burst).

Thus, after decoding the data of a received uplink transmission from a user apparatus, a network apparatus is configured to send acknowledgement data regarding the received uplink transmission to the user apparatus in the next downlink burst.

In the following, reference is only made to the case of when additional PHICH resources are used. However, it is understood that the following techniques may also be applied when only the legacy PHICH resources are used.

In this example, it is proposed to reserve the additional PHICH resource for each transmitting uplink user apparatus only in specific time instances/subframes.

As mentioned above, various patterns and/or offsets relative to a specified subframe may be applied to determine the specific time instances/subframes in which the additional PHICH data is provided.

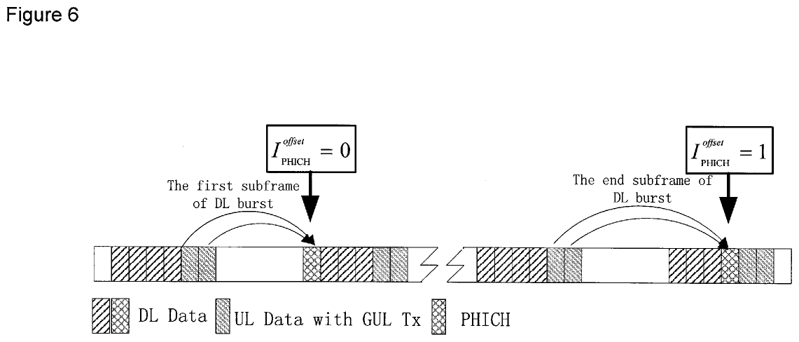

For an example (illustrated with respect to FIG. 6), a one-bit indicator I_{PHICH}^{offset} is designed to indicate whether PHICH is presented in the first subframe or last subframe of the downlink burst. Herein if I_{PHICH}^{offset}=0, PHICH is presented in the first subframe of the DL burst, otherwise PHICH is presented in the end subframe of the DL burst. This indicator may be pre-defined or configured by the network apparatus via RRC signalling.

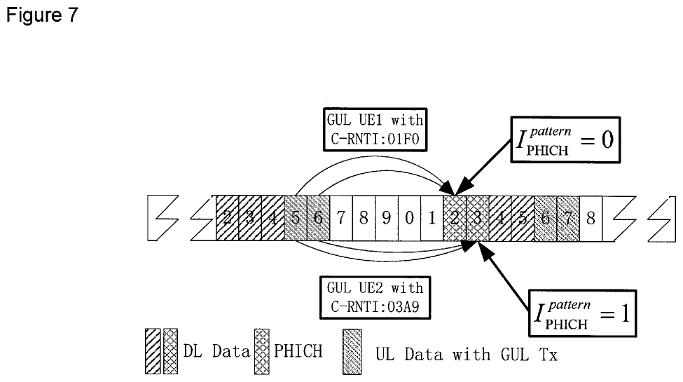

As another example (illustrated with respect to FIG. 7), the additional PHICH resources are only provided in subframes corresponding to a specific transmission pattern, e.g. the odd or even subframes of numbered subframes, which may be all the subframes of a radio frame or all the downlink subframes of a downlink burst.

As shown in FIG. 7, there is provided a one-bit indicator I_{PHICH}^{pattern} that is designed to indicate whether PHICH is presented in the odd or even subframes of a radio frame. Herein if I_{PHICH}^{pattern}=0, PHICH is only presented in the even subframe of a radio frame otherwise PHICH is presented in the even subframes.

The indicator mentioned above with respect to FIG. 7 may be implicitly bundled with a cell identity of the uplink transmitting user apparatuses (such as the cell-radio network temporary identified). For example, a user apparatus having an even cell identify (e.g. UE1), may have associated acknowledgement data/additional PHICH resources provided by the network apparatus in even numbered subframes; In contrast, for a user apparatus having an odd-numbered cell identity (e.g. UE2), associated acknowledgement data/additional PHICH resources provided by the network apparatus in odd numbered subframes.

In both of the above-mentioned examples, the indicator may be explicitly configured by the network apparatus via radio resource control signalling.

In both of the above-mentioned examples, the indicator may be implicitly set by the operating communication protocol. An example of how this may be done is provided below.

In a further example, the indicator mentioned above (e.g. an offset relative to a specified subframe of a downlink burst and/or the index of transmission pattern) may be implicitly indicated by a randomization function in order to enable each grant-less uplink user apparatus circularly using PHICH resource. A possible randomisation function is provided below as an illustrative example:

i_{PHICH}=mod(I_{Frame}+I_{UE_ID},N_{PHICH})

where I_{Frame} denotes the index of a radio frame corresponding to the first radio frame of uplink transmissions pending for acknowledgement data feedback; I_{UE_ID} denotes an identification of a particular user apparatus (e.g. a cell-specific identity of the user apparatus such as the cell-radio network temporary identifier, C-RNTI); N_{PHICH} denotes either the number of possible transmission patterns that are configured by the network apparatus via radio resource control signalling, or N_{PHICH} denotes the number of downlink subframes in a downlink burst. If N_{PHICH} denotes the number of possible transmission patterns, i_{PHICH} is the index of transmission pattern; if N_{PHICH} denotes the number of downlink subframes in a downlink burst, i_{PHICH} is an offset relative to a specified subframe in a downlink burst.

The above-described examples relate to the definition of a transmission opportunity (e.g. identifying a subframe) for transmitting acknowledgement data. The transmission opportunity may be part of a transmission opportunity acquired by the network apparatus within a downlink burst and/or may be a share of a transmission opportunity acquired by a user apparatus following an uplink transmission by that user apparatus.

Thus, if a network apparatus detects an uplink transmission in subframe n, the network apparatus may be configured to send acknowledgement of this transmission to the user apparatus in subframe n+k_{PHICH} only if the following conditions are satisfied:
The transmission opportunity of the additional PHICH resources is pre-configured in this subframe; and
The feedback delay of HARQ-ACK k_{PHICH} is not less than (i.e. is equal to or more than) a minimal processing delay, e.g. 4 ms.

As an example, after detecting a grant-less uplink transmission from UE1 in subframe number 5, the network apparatus may be configured to send acknowledgement data to UE1 via PHICH in subframe number 2 of next frame, based on the configuration of PHICH transmission pattern if the clear channel assessment (e.g. listen before talk) is successful.

In combination with or separate to the above, there is provided a third mechanism for mitigating a problem that arises when implementing the PH ICH system into a grant-less transmission system.

This third mechanism relates to defining which specific PHICH resources are assigned for providing acknowledgement to a particular user apparatus.

In particular, there is provided a PHICH resource mapping mechanism for mapping at least one PHICH resource to a particular user apparatus. This mapping mechanism utilises an identification associated with an uplink transmission made by the particular user apparatus to the network apparatus in an uplink transmission. This identification is used to support at least one of implicit and explicit mapping.

In an LTE-specific embodiment, the identification is a HARQ process ID of the corresponding grant-less uplink transmission to which the acknowledgement data relates. A HARQ process ID identifies a particular HARQ process. A HARQ process is the process defined by the transmission of uplink data and an associated retransmission of acknowledgment data. The HARQ process remains open until acknowledgement data for the transmitted uplink data is received, or until a timer expires.

In a first example, an example of an implicit mapping mechanism is provided, in which the HARQ process ID is used to map a specific user into PHICH resources (i.e. PHICH group number and orthogonal sequence index). An example of equations that may be used to effect this mapping is labelled as (4) below.

n_{PHICH}^{group}(I_{hid}, I_{cw})=(I_{uid}×N_{harq}×N_{cw}+N_{harq}×(I_{cw}−1)+I_{hid})mod N_{PHICH,total}^{group}

n_{PHICH}^{seq}(I_{hid}, I_{cw})=(└(I_{uid}×N_{harq}×N_{cw}+N_{harq}×(I_{cw}−1)+I_{hid})/N_{PHICH,total}^{group}┘)mod(2N_{SF}^{PHICH}) (4)

In these equations, N_{cw} and I_{cw}, denote the maximum Codeword (CW) size and the CW index of a transport block (a transport block is the data passed from an upper layer or medium access control layer to a physical layer for transmission), respectively; N_{harq} and I_{hid} respectively denote the maximum number of HARQ processes and the HARQ process ID of the user apparatus; I_{uid} denotes the signature of user apparatus which could be the cell identity mentioned above (e.g. the cell radio network temporary identifier) or configured by a network apparatus via activation signalling or radio resource control signalling. Furthermore, N_{PHICH,total}^{group} and N_{SF}^{PHICH} respectively denote the number of PHICH groups in PHICH resource pool and the number of PHICHs per PHICH group.

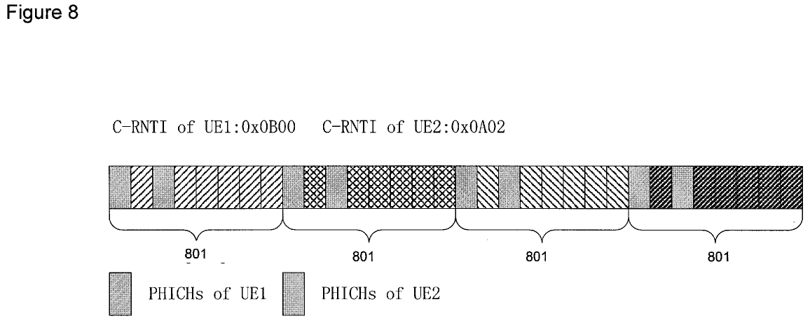

This example may be illustrated with respect to FIG. 8.

In FIG. 8, there are provided 4 PHICH groups 801. The first resource of each group is used for UE1 acknowledgement data whilst the third resource of each group is used for UE2 acknowledgement data. It is assumed that the maximum number of HARQ processes and the maximum code word size for a user apparatus are 4 and 1 respectively, i.e. N_{harq}=4 and N_{cw}=1. Furthermore, the cell identity of UE1 is assumed to be 0x0B00 and the cell identity of UE2 is assumed to be 0x0A02.

According to the mapping function detailed above, the reserved PHICH resources for four HARQ processes of UE1 are [0,0][1,0][2,0][3,0] respectively, and the reserved PHICH resources for four HARQ processes of UE2 are [0,2][1,2][2,2][3,2] respectively. This is shown in FIG. 8.

An advantage of using this implicit mechanism is that extra signalling is not required to enable the mapping to be performed. However, as the number of user apparatuses for which acknowledgment data needs to be provided increases, resource collision may occur.

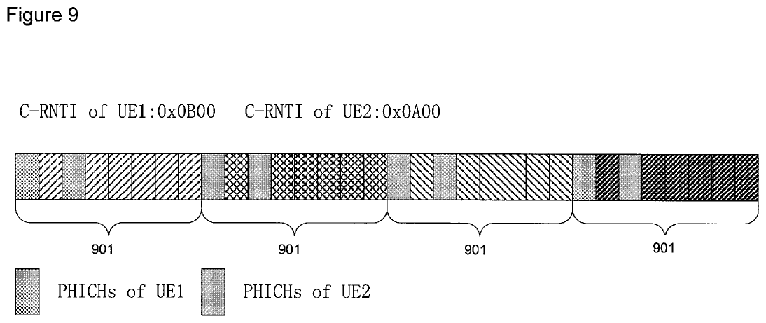

Resource collision may be mitigated by using an explicit signalling mechanism. As example of such a mechanism is now described with reference to FIG. 9.

Like FIG. 8, FIG. 9 shows four PHICH groups 901. The first resource of each group is used for UE1 acknowledgement data whilst the third resource of each group is used for UE2 acknowledgement data. It is assumed that, as per the above example of FIG. 8, the maximum number of HARQ processes and the maximum code word size for a user apparatus are 4 and 1 respectively, i.e. N_{harq}=4 and N_{cw}=1. Furthermore, the cell identity of UE1 is assumed to be 0x0B00 and the cell identity of UE2 is assumed to be 0x0A00. Thus, for the example shown in FIG. 9, the basic assumptions are the same as the example in FIG. 8 except that the cell identity of UE2 is different. Through configuration of starting position of PHICH (0, 2) for UE2, PHICH resource collision among two UEs may be avoided.

In this explicit signalling mechanism, the network apparatus is configured to provide each user equipment for which acknowledgement data is to be provided with an indication of a starting position of the first HARQ process ID for the first transport block in the PH ICH resource pool.

An example of a specific set of equations that may be used for effectuating such a mapping are provided below.

nₛₜₐᵣₜ(n_{PHICH}^{group}(1,1), n_{PHICH}^{seq}(1,1))=n_{PHICH}^{group}(1,1)×(2N_{SF}^{PHICH})+n_{PHICH}^{seq}(1,1)

n_{PHICH}^{group}(I_{hid}, I_{cw})=(nₛₜₐᵣₜ(n_{PHICH}^{group}(1,1), n_{PHICH}^{seq}(1,1))+N_{harq}×(I_{cw}−1)+(I_{hid}−1)) mod N_{PHICH,total}^{group}

n_{PHICH}^{seq}(I_{hid}, I_{cw})=(└(nₛₜₐᵣₜ(n_{PHICH}^{group}(1,1), n_{PHICH}^{seq}(1,1))+N_{harq}×(I_{cw}−1)+(I_{hid}−1))/N_{PHICH,total}^{group}┘)mod(2N_{SF}^{PHICH}) (5)

In these equations, n_{PHICH}^{group}(1,1) and n_{PHICH}^{seq}(1,1) denote the PHICH group number and the index of orthogonal sequence within the PHICH group for first HARQ process ID and codeword, whilst the other factors have the same meaning as equation (4).

In contrast to the implicit signalling option described above in relation to FIG. 8, equation (5) provides a pair of radio resource control signalling parameters (n_{PHICH}^{group}(1,1), n_{PHICH}^{seq}(1,1)) that are usable to indicate the start position of PHICH for the first HARQ ID to avoid PHICH resource collision. Through the use of these start-position indicators, the network apparatus is able to ensure the acknowledgment data feedback for each grant-less uplink user apparatus will be allocated a unique PHICH resource by controlling the start position of PHICH of each user apparatus and the number of user apparatuses for which acknowledgement data is being provided.

Throughout the above, the terms “network apparatus” and “cell” are used interchangeably, as a network apparatus may define a coverage area of at least one cell through the maximum range of its transmissions.

It should be understood that each block of the flowchart of the Figures and any combination thereof may be implemented by various means or their combinations, such as hardware, software, firmware, one or more processors and/or circuitry.

It is noted that whilst embodiments have been described in relation to one example of a standalone LTE networks, similar principles maybe applied in relation to other examples of standalone 3G, LTE or 5G networks. It should be noted that other embodiments may be based on other cellular technology other than LTE or on variants of LTE. Therefore, although certain embodiments were described above by way of example with reference to certain example architectures for wireless networks, technologies and standards, embodiments may be applied to any other suitable forms of communication systems than those illustrated and described herein.

In particular, it is understood that, throughout the above that reference to specific communication protocols (such as Multefire) are used to illustrate various principles and are not limiting. Similar issues to those illustrated by example may arise in other grant-less transmission systems to Multefire.

It is also noted herein that while the above describes example embodiments, there are several variations and modifications which may be made to the disclosed solution without departing from the scope of the present invention.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
determining a first control channel comprising a first plurality of resources in dependence on a first parameter and the downlink bandwidth;
determining a second plurality of resources available on at least a second control channel; and
combining the first and second plurality of resources to define an effective control channel for use in signalling acknowledgement data to at least one user apparatus.

2. A method as claimed in claim 1, further comprising:
receiving and/or transmitting a broadcast comprising the first parameter prior to determining the first control channel; or
storing the first parameter to determine the first control channel, wherein the first parameter is static and is set by a communications protocol.

3. A method as claimed in claim 1, wherein the at least one second control channel is at least one of: a physical downlink control channel; and an enhanced physical downlink control channel.

4. A method as claimed in claim 1, wherein determining a second plurality of resources comprises at least one of:
determining that at least three resource element groups are available on a physical downlink control channel;
determining that at least one control channel element is available on a physical downlink control channel; and
determining that at least one enhanced control channel element is available on an enhanced physical downlink control channel.

5. A method as claimed in claim 4, further comprising performing said determining in dependence on at least one second parameter,
wherein said at least one second parameter is:
I_{PHICH}^{spare} when determining that at least three resource element groups are available on a physical downlink control channel;
n_{PHICH}^{CCE} when determining that at least one control channel element is available on a physical downlink control channel; and
n_{PHICH}^{ECCE} that at least one enhanced control channel element is available on an enhanced physical downlink control channel.

6. A method as claimed in claim 1, further comprising:
only determining a second plurality of resources for transmission of acknowledgment data in a subframe fulfilling a predetermined transmission opportunity.

7. A method as claimed in claim 6, wherein the predetermined transmission opportunity is at least one of: specific subframes of a downlink transmission burst; and subframes falling within a predefined pattern of subframes, and further comprising transmitting an indication of the predetermined transmission opportunity to a user apparatus; and/or
receiving an indication of the predetermined transmission opportunity from a network apparatus, and
transmitting acknowledgement data to the at least one user apparatus using the effective control channel only when the predetermined transmission opportunity is fulfilled; and/or
receiving acknowledgement data from a network apparatus using the effective control channel only when the predetermined transmission opportunity is fulfilled .

8. (canceled)

9. (canceled)

10. A method as claimed in claim 1, further comprising:
transmitting acknowledgement data to the at least one user apparatus using the effective control channel only when the feedback delay of providing the acknowledgement data is not less than a minimal processing delay.

11. A method as claimed in claim 1, further comprising:
mapping an uplink transmission to one of the first and second plurality of resources using an identification of the uplink transmission wherein the identification is a hybrid automatic request process ID, and
wherein the mapping comprises implicitly mapping said uplink transmission to one of the first and second plurality of resources;
wherein the mapping comprises:
transmitting and/or receiving a signal that indicates a start position of the mapping using said identification of the uplink transmission; and
explicitly mapping said uplink transmission to one of the first and second plurality of resources in dependence on the start position.

12. (canceled)

13. (canceled)

14. (canceled)

15. A method as claimed in claim 1, further comprising:
mapping at least one of the first plurality of resources to a first group of user apparatuses;
mapping at least one of the second plurality of resources to a second group of user apparatuses; and either:
transmitting acknowledgement data for at least one of the first group of user apparatuses on the at least one of the first plurality of resources; and
transmitting acknowledgement data for at least one of the second group of user apparatuses on the at least one of the second plurality of resources; or
receiving acknowledgement data for at least one of the first group of user apparatuses on the at least one of the first plurality of resources.

16. A method as claimed in claim 1, wherein the acknowledgement data is associated with a previous grant-less uplink transmission.

17. An apparatus comprising:
at least one processor; and
at least one memory comprising code that, when executed on the at least one processor, causes to the apparatus to perform the method steps claim 1.

18. A computer program comprising computer executable instructions, which when executed by a computer, cause the computer to perform the method steps of claim 1.

19. A method comprising:
transmitting uplink data to a network apparatus;
receiving acknowledgement data on at least part of an effective channel in response to the transmitted uplink data, wherein the effective channel comprises a first control channel comprising a first plurality of resources that are defined in dependence on a first parameter and the downlink bandwidth and a second control channel comprising a second plurality of resources.

20. A method as claimed in claim 19, wherein the receiving comprises receiving the acknowledgement data on: at least some of the first plurality of resources; or at least some of the second plurality of resources; or at least some of the first and second plurality of resources.

21. A method as claimed in claim 19, further comprising autonomously determining the effective channel.

22. A method as claimed in claim 19, further comprising:
receiving an indication of the at least part of an effective channel from the network apparatus; and
using the received indication to determine when the acknowledgement data is to be received.

23. A method as claimed in claim 19, further comprising:
mapping the uplink transmission to one of the first and second plurality of resources using an identification of the uplink transmission, and
wherein the identification is a hybrid automatic request process ID, and
wherein the mapping comprises implicitly mapping said uplink transmission to one of the first and second plurality of resources, and
wherein the mapping comprises: receiving a signal that indicates a start position of the mapping using said identification of the uplink transmission; and
explicitly mapping said uplink transmission to one of the first and second plurality of resources in dependence on the start position.

24. (canceled)

25. (canceled)

26. (canceled)

27. A method as claimed in claim 19, further comprising:
wherein the effective channel only comprises the second plurality of resources for subframes fulfilling a predetermined transmission opportunity, and
wherein the predetermined transmission
opportunity is at least one of: specific subframes of a downlink transmission burst; and subframes falling within a predefined pattern of subframes
further comprising:
receiving an indication of the predetermined transmission opportunity from a network apparatus, and
further comprising:
receiving acknowledgement data from a network apparatus using the effective control channel only when the predetermined transmission opportunity is fulfilled.

28. (canceled)

29. (canceled)

30. (canceled)

31. An apparatus comprising:
at least one processor; and
at least one memory comprising code that, when executed on the at least one processor, causes to the apparatus to perform the method steps of claim 19.

32. A computer program comprising computer executable instructions, which when executed by a computer, cause the computer to perform the method steps of claim 19.
